(19) United States
(12) Patent Application Publication
(10) Pub. No.: US 2014/0035445 A1
(43) Pub. Date: Feb. 6, 2014

(54) ROTATING ELECTRIC MACHINE AND ELECTRIC POWER STEERING APPARATUS

(71) Applicant: DENSO CORPORATION, Kariya-city (JP)

(72) Inventors: Nobuhiko URYU, Kariya-city (JP); Masashi YAMASAKI, Obu-city (JP)

(73) Assignee: DENSO CORPORATION, Kariya-city (JP)

(21) Appl. No.: 13/952,087

(22) Filed: Jul. 26, 2013

(30) Foreign Application Priority Data
Aug. 3, 2012 (JP) 2012-172917

(51) Int. Cl. H02K 11/00

(52) U.S. Cl. CPC H02K 11/0073
USPC 310/68 D

(57) ABSTRACT

A rotating electric machine for driving a drive object includes a heat sink having a cavity on a first face, a power module disposed on the heat sink for switching a power supply for the winding, a power wiring part disposed on the first face of the heat sink and electrically connected to the power module for flowing a drive electric current to the winding, a control wiring part disposed on a second face of the heat sink and electrically connected to the power module for flowing a control electric current that controls the power module, and at least one electrolytic capacitor disposed in the power wiring part and housed in the cavity, thereby preventing an abnormality of the electrolytic capacitor from causing an abnormality of the control wiring part.

### CROSS-REFERENCE TO RELATED APPLICATION

The present application is based on and claims the benefit of priority of Japanese Patent Application No. 2012-172917 filed on Aug. 3, 2012, the disclosure of which is incorporated herein by reference.

### TECHNICAL FIELD

The present disclosure generally relates to a rotating electric machine for driving an electric power steering apparatus.

### BACKGROUND

Generally, a rotating electric machine has a motor part and a control part formed in a single body. For example, the rotating electric machine in a patent document 1 (i.e., Japanese Patent Laid-Open No. 2011-250489), has a control unit, a heat sink to cool a power module, a power wiring part for flowing a drive electric current to the motor part, and a control wiring part for controlling a control electric current to the power module. The heat sink includes two heat radiation blocks and a connecting part for connecting (i.e., bridges) short side ends of the two board-shaped heat radiation blocks. The power wiring part is disposed on one side of the heat sink. The control wiring part is disposed on the opposite side of the heat sink, that is, on an opposite side that is opposite to a side having the power wiring part disposed thereon. In such a structure, an electrolytic capacitor for reducing a ripple of the drive electric current is disposed in the power wiring part, in an interposing manner between the two heat radiation blocks. That is, in such manner, a space between two heat radiation blocks is utilized for efficient arrangement of electronic components.

The electrolytic capacitor disposed in the power wiring part may generate heat when an excessive and/or abnormal voltage is applied thereto. When such heat generation continues, electrolytic solution may leak from the electrolytic capacitor, and/or the electrolytic capacitor may explode. In the rotating electric machine of the patent document 1, long side ends of the two heat radiation blocks are not connected with each other and the connecting part is formed to connect only the short side ends of the two heat radiation blocks. In other words, a large portion of a control wiring part is not covered by the heat sink and is exposed to the electrolytic capacitor. Therefore, if the electrolytic capacitor were to explode, debris from the exploded capacitor may contact electronic components in the control wiring part causing damage to the electronic components and/or the control wiring part itself.

Further, if the rotating electric machine of the patent document 1 is used as a drive source of the electric power steering apparatus, where the control wiring part is positioned vertically below the electrolytic capacitor, the control wiring part may be damaged by electrolytic solution leaking from the electrolytic capacitor and dripping onto the electronic components of the control wiring part causing abnormal function of the control wiring part.

If the electrolytic capacitor explodes or leaks electrolytic solution, the control wiring part may function abnormally to cause the drive of the rotating electric machine to be disabled and the electric power steering apparatus to stop functioning.

The electrolytic capacitor functions to reduce a ripple of the drive electric current. In other words, the electrolytic capacitor provides a noise protection function. Therefore, a leaking and/or exploding electrolytic capacitor should only lead to the loss of the noise protection function and should not affect other parts, such as the drive of the rotating electric machine, the operation of the electric power steering apparatus, and/or the travel of the vehicle. However, a leaking or exploding electrolytic capacitor in the patent document 1 may likely lead to the abnormal functioning of the control wiring part resulting in the failure of the electric power steering apparatus.

### SUMMARY

It is an object of the present disclosure to provide an electric power steering apparatus utilizing a rotating electric machine wherein the rotating electric machine prevents the damaging of a control wiring part caused by an abnormality of an electrolytic capacitor.

In an aspect of the present disclosure, the rotating electric machine for driving a drive object, includes a motor case, a stator, a winding, a rotor, a shaft, an output rod, a heat sink, a power module, a power wiring part, a control wiring part, an electrolytic capacitor, and electronic components. The motor case has a cylinder shape. The stator is housed in the motor case. The winding is wound on the stator. The rotor is rotatably disposed inside of the stator. The shaft is coupled to and disposed at a center of the rotor. The output rod is disposed on the shaft and outputs the rotation of the rotor to a drive object through a connection with the drive object. The heat sink is disposed on the motor case in an axial direction, having a cavity on a first face of the heat sink. The power module is disposed on the heat sink and switches a power supply for the winding. By disposing the power module on the heat sink, heat caused by an operation of the power module is radiated through the heat sink. The power wiring part is disposed on the first face of the heat sink and is electrically connected to the power module. The power wiring part is used to flow a drive electric current to the winding. The control wiring part is disposed on a second face of the heat sink and is electrically connected to the power module. The control wiring part is used to flow a control electric current for controlling the power module. At least one electrolytic capacitor is disposed in the power wiring part and housed in the cavity of the heat sink. The electrolytic capacitor is disposed, for example, to reduce a ripple of the drive electric current. The electronic components are disposed on a side of the power wiring part facing the first face of the heat sink. The electronic components include, for example, coils and the like that constitute a filter circuit for filtering a power supply electric current.

The electrolytic capacitor of the present disclosure is disposed on an opposite side of the heat sink relative to the control wiring part, to be housed in the cavity of the heat sink. In other words, a control wiring part side of the electrolytic capacitor is almost entirely covered by the heat sink. Therefore, even if the electrolytic capacitor generates heat and explodes due to an excessive and/or abnormally applied electric voltage, a broken piece of the exploded electrolytic capacitor is prevented from contacting the control wiring part, thereby preventing damage to the control wiring part. Therefore, a situation when an abnormality of the electrolytic capacitor (i.e., an explosion) causing an abnormality of the control wiring part may be avoided.

Further, when the rotating electric machine is arranged so that the cavity of the heat sink faces an upward vertical direction with respect to gravity, if an electrolytic capacitor leaks electrolytic solution due to heat generation caused by an excessive and abnormal application of electric voltage, the electrolytic solution leaking from the electrolytic capacitor may be caught by the cavity. Therefore, the leaking solution from the capacitor may be prevented from dripping onto the control wiring part. Therefore, a situation when abnormality of the electrolytic capacitor (i.e., solution leakage) causing an abnormality of the control wiring part may be avoided.

As described above, the present disclosure is an effective solution preventing an abnormality of the control wiring part which may otherwise be caused by an abnormality of the electrolytic capacitor.

### BRIEF DESCRIPTION OF THE DRAWINGS

Other objects, features and advantages of the present disclosure will become more apparent from the following detailed description disposed with reference to the accompanying drawings, in which:

FIG. 1 is a cross-sectional view of a rotating electric machine in a first embodiment of the present disclosure;

FIG. 2 is a block diagram of the rotating electric machine in the first embodiment of the present disclosure, which is applied to an electric power steering apparatus;

FIG. 3 is an exploded perspective view of the rotating electric machine in the first embodiment of the present disclosure;

FIG. 4A is a side view of a heat sink of the rotating electric machine in the first embodiment of the present disclosure;

FIG. 4B is a view of the heat sink of FIG. 4A seen in a IV B arrow direction; FIG. 4C is a view of the heat sink of FIG. 4A seen in a IV C arrow direction;

FIG. 4D is a perspective view of the heat sink;

FIG. 4E is a perspective view of the heat sink;

FIG. 5A is a side view of a power wiring part, an electrolytic capacitor and electronic components of the rotating electric machine in the first embodiment of the present disclosure;

FIG. 5B is a view of the parts of FIG. 5A seen in a V B arrow direction;

FIG. 5C is a view of the parts of FIG. 5A seen in a V C arrow direction;

FIG. 5D is a perspective view of the parts of FIG. 5A;

FIG. 6 is a block diagram of the electric power steering apparatus in a second embodiment of the present disclosure; and

FIG. 7 is a cross-sectional view of the rotating electric machine applied to the electric power steering apparatus in the second embodiment of the present disclosure.

### DETAILED DESCRIPTION

Plural embodiments regarding a rotating electric machine and an electric power steering apparatus in the present disclosure are described in the following with reference to the drawings. Like parts have like numbers in the description of those embodiments for the brevity of the description.

### First Embodiment

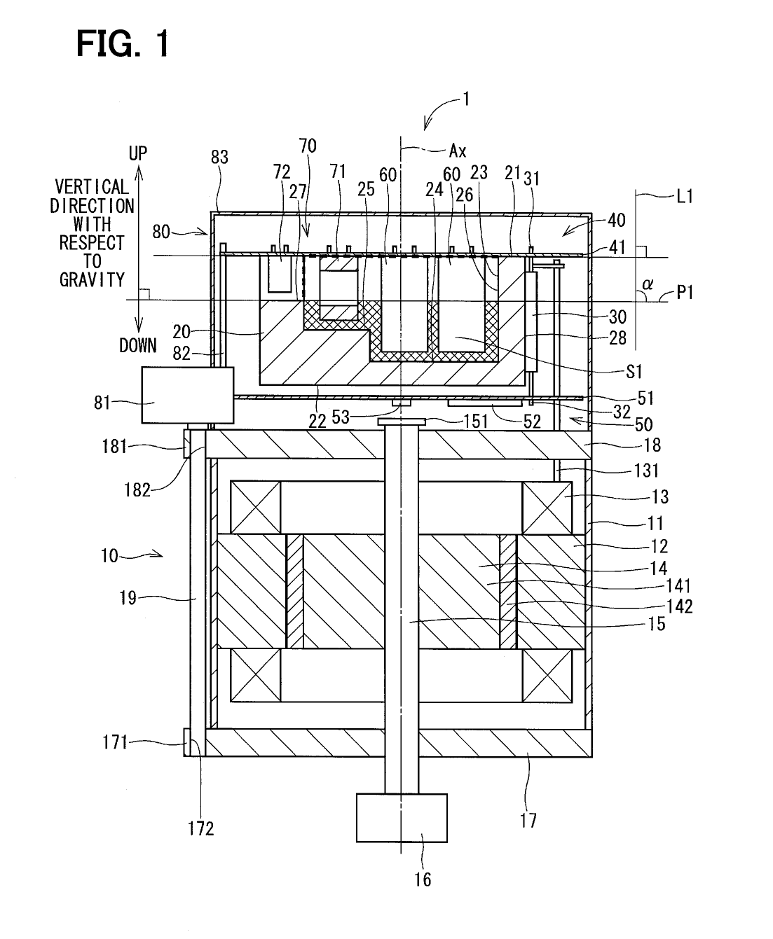

The first embodiment of the rotating electric machine in the present disclosure is shown in FIG. 1. A rotating electric machine 1 is driven by receiving an electric power supply and is used in an electric power steering apparatus to assist a steering operation of the vehicle.

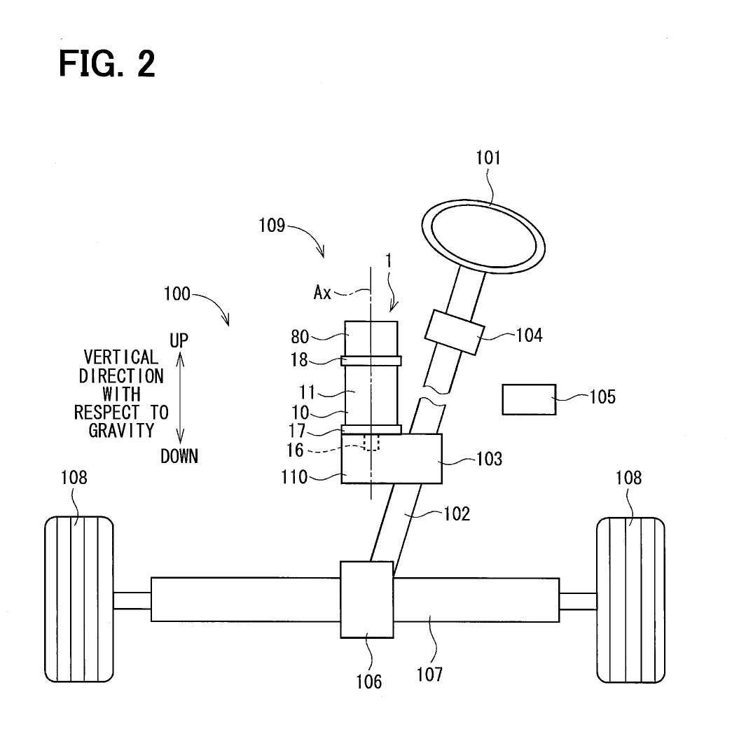

FIG. 2 illustrates a steering system 100 having an electric power steering apparatus 109. In the electric power steering apparatus 109, a torque sensor 104 is disposed on a steering shaft 102 and connected to a steering wheel 101. The torque sensor 104 detects a steering torque input to the steering shaft 102 from the steering wheel 101 by a vehicle driver.

A pinion gear 106 is disposed on a tip of the steering shaft 102, and the pinion gear 106 is engaged with a steering rack 107. On both ends of the steering rack 107, a pair of tires 108 are connected in a rotatable manner through a tie rod or the like.

In such manner, when the vehicle driver rotates the steering wheel 101, the steering shaft 102 connected to the steering wheel 101 rotates and the rotation motion of the steering shaft 102 is converted into a linear motion of the steering rack 107 by the pinion gear 106. The pair of tires 108 is steered by an angle according to a displacement of the linear motion of the steering rack 107

The electric power steering apparatus 109 includes the rotating electric machine 1 for generating a steering-assist torque and a reduction gear 103 for reducing a rotation speed of the rotating electric machine 1 and transmits the reduced rotation to the steering shaft 102 together with other parts. In the present embodiment, the rotating electric machine 1 is disposed on a housing 110 of the reduction gear 103.

The rotating electric machine 1 is, for example, a three-phase brushless motor and is driven by having an electric power supply from a battery (not shown). The rotating electric machine 1 provides a forward/reverse rotation to the reduction gear 103. The reduction gear 103 corresponds to a drive object in claims. The electric power steering apparatus 109 includes the above-described torque sensor 104 and a vehicle speed sensor 105 for detecting a vehicle speed.

By having such a configuration, the electric power steering apparatus 109 generates a steering-assist torque to assist a steering of the steering wheel 101 from the rotating electric machine 1 according to a signal from the torque sensor 104 and a signal from the speed sensor 105, and transmits the torque to the steering shaft 102 via the reduction gear 103. In the present embodiment, the electric power steering apparatus 109 is a column-assist type electric power steering apparatus as described above.

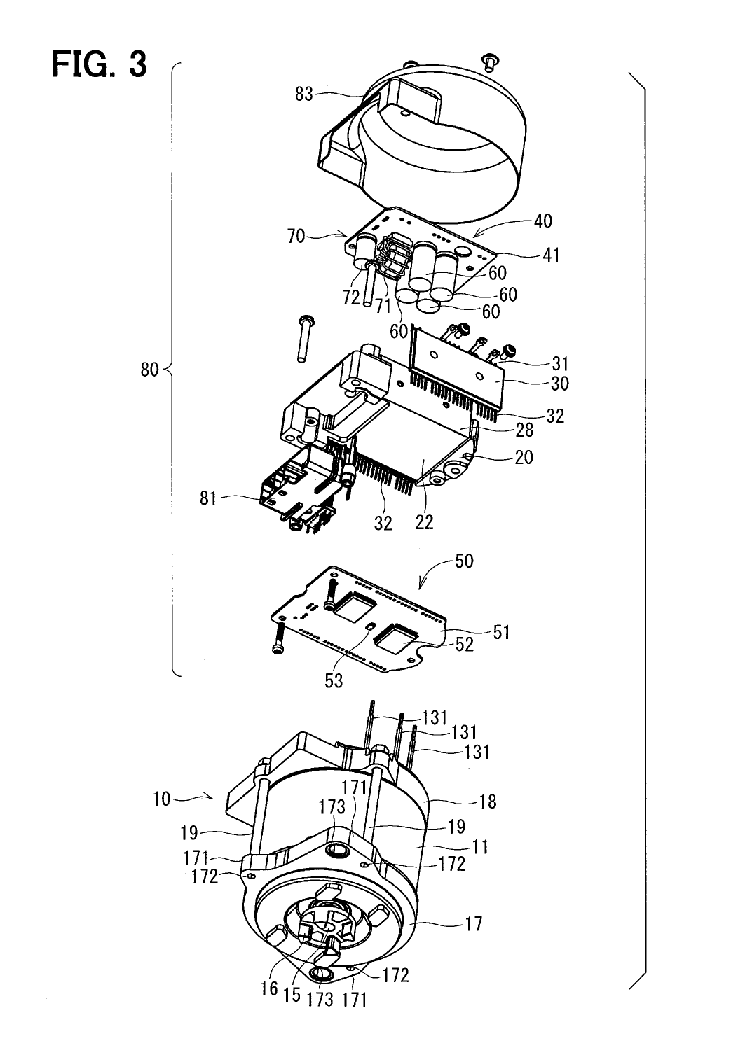

As shown in FIG. 1 and FIG. 3, the rotating electric machine 1 has a motor part 10 and a control part 80. The motor part 10 of the rotating electric machine 1 includes a motor case 11, a stator 12, a winding 13, a rotor 14, a shaft 15, an output rod 16 and the like. Further, the control part 80 of the rotating electric machine 1 includes a heat sink 20, a power module 30, a power wiring part 40, a control wiring part 50, an electrolytic capacitor 60, electronic components 70 and the like.

The motor case 11 may be formed substantially in the shape of a cylinder from a material such as metal. The stator 12 may also be formed substantially in the shape of a cylinder from a material such as metal, for example, iron or the like, and is fixedly disposed and housed inside of the motor case 11. The winding 13 is wound on the stator 12.

The rotor 14 has a rotor core 141 and a magnet 142. The rotor core 141 may be, for example, formed substantially in the shape of a cylinder from a material such as metal, and is coaxially disposed in an inside of the stator 12. The magnet 142 may also be formed substantially in the shape of a cylinder and is disposed on an outer wall of the rotor core 141. The shaft 15 may be formed in the shape of a rod from a material such as metal and is disposed at a center of the rotor 14 such that the shaft 15 is connected to the rotor 14.

In the present embodiment, the motor part 10 includes a front end cap 17, a rear end cap 18, and a through bolt 19.

The front end cap 17 may be formed in the shape of a disc from a material such as metal and is disposed to cover the front end of the motor case 11. The front end cap 17 has, as a portion protruding radially-outwardly from an outer wall of the motor case 11, a front flange ear 171 disposed on an outer periphery. In the present embodiment, three front flange ears 171 are formed on the front end cap 17. A front hole 172 is formed in each of the three front flange ears 171.

The front end cap 17 has a front shaft hole, into which the shaft 15 is inserted. The front shaft hole supports a front end of the shaft 15. In other words, the front end cap 17 serves as a bearing for the front end of the shaft 15.

The rear end cap 18 may be formed in the shape of a disc from a material such as metal and is disposed to cover the rear end of the motor case 11 relative to the front end cap 17. The rear end cap 18 has, as a portion protruding radially-outwardly from an outer wall of the motor case 11, a rear flange ear 181 disposed on an outer periphery, positioned opposite to the front flange ear 171. In the present embodiment, three rear flange ears 181 are formed on the rear end cap 18. A rear hole 182 is formed at a position corresponding to the front hole 172 on each of the three rear flange ears 181.

The rear end cap 18 has a rear shaft hole, into which the shaft 15 is inserted. The rear shaft hole supports the rear end of the shaft 15, positioned opposite to the front end of the shaft 15. In other words, the rear end cap 18 serves as a bearing for the rear end of the shaft 15.

With the above configuration, the rotor 14 is rotatably disposed inside of the stator 12 together with the shaft 15. An airgap may be defined in a cylindrical shape between an outer wall of the rotor 14 (i.e., the magnet 142) and an inner wall of the stator 12.

The output rod 16 may be formed from a material such as metal and is disposed on the front end of the shaft 15. More practically, the output rod 16 is disposed on the front end of the shaft 15 and extends from the front end cap 17 in a direction opposite to the rear end cap 18. The output rod 16 may output the rotation of the rotor 14 and the shaft 15 to the reduction gear 103, through the connection with the reduction gear 103.

The through bolts 19 are inserted into the front holes 172 and the rear holes 182 to fasten the rear flange ears 181 and the front flange ears 171 together. The through bolts 19 exert a predetermined amount of axial force to fastening positions of the through bolt 19 on the front flange ears 171 and the rear flange ears 181. In such a manner, the motor case 11 is held in a bound state between the front end cap 17 and the rear end cap 18.

In the present embodiment, a fastening hole 173 is formed in two of the three front flange ears 171, as shown in FIG. 3.

Into the fastening hole 173, a bolt (not illustrated) is inserted to fasten the housing 110 of the reduction gear 103 to the front flange ear 171. The rotating electric machine 1 is installed onto the housing 110 of the reduction gear 103 in such a manner.

The control part 80 is disposed on a side of the rear end cap 18 of the motor part 10 to form a single body with the motor part 10. In other words, the control part 80 is disposed on the opposite side of the motor case 11 relative to the output rod 16.

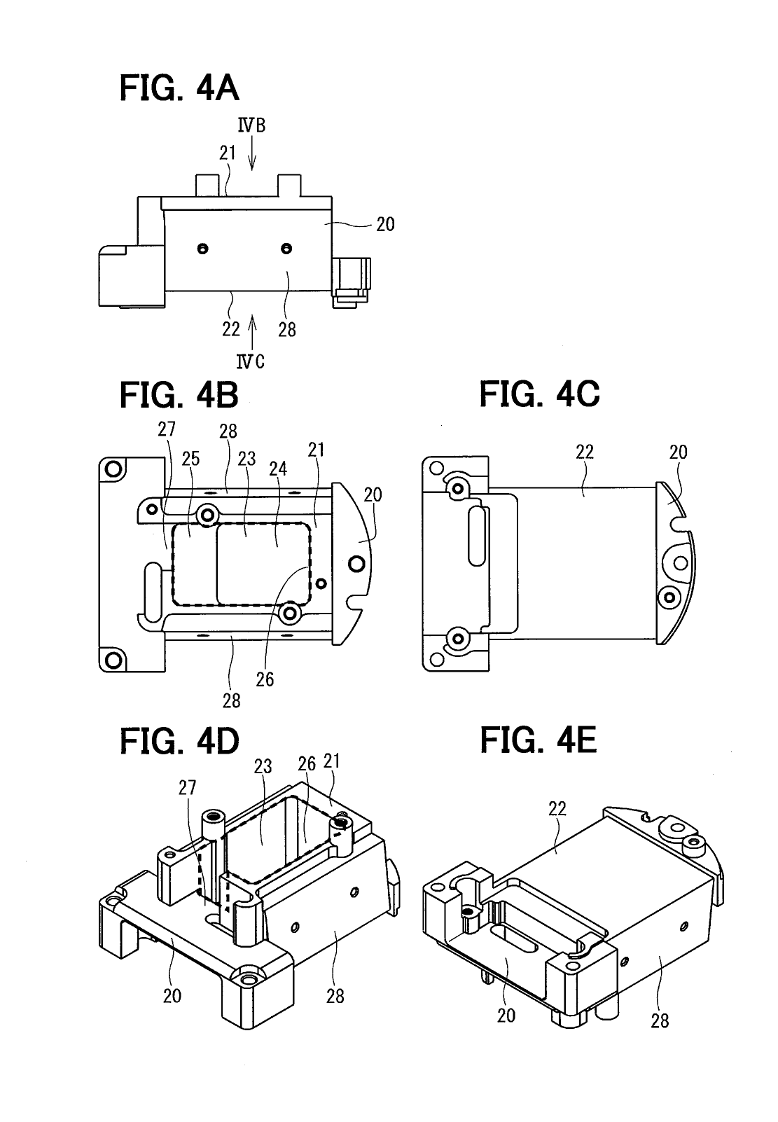

The heat sink 20 is disposed on the opposite side of the motor case 11, that is, on the opposite side of the rear end cap 18 relative to the motor case 11. The heat sink 20 has a cavity 23 along a top face 21 of the heat sink 20 (i.e., in a vertical upward direction with respect to gravity, as shown in FIG. 1). The cavity 23 has an inner wall defined by a first bottom face 24, where the first bottom face 24 is parallel to the top face 21. Further, the inner wall of the cavity 23 is also defined by a second bottom face 25, where the second bottom face 25 is parallel to the top face 21 and is closer in distance to the top face 21 than the first bottom face 24. Moreover, the cavity 23 has a side face 26 that is perpendicular to the first and second bottom faces 24, 25. Even further, the heat sink 20 has a cutout portion 27 formed on the side face 26 of the cavity 23, by removing a part of the side face 26 (see FIG. 1, FIG. 4B, FIG. 4D). In such a manner, the heat sink 20 has an open end (i.e., on a side of the heat sink 20 along the top face 21 of the cavity 23), as indicated by a dashed line in FIG. 1, FIG. 4B, FIG. 4D).

The power module 30 is attached directly onto an outer wall 28 of the heat sink 20. For example, the power module 30 may be a switching element such as an Insulated Gate Bipolar Transistor (IGBT) or the like, for the switching of an electric power supply for the winding 13. In the present embodiment, two power modules 30 are provided. By attaching the power module 30 directly to the heat sink 20, heat from the power module 30 (e.g., generated while the power module 30 is in operation) is radiated through the heat sink 20.

The power wiring part 40 is disposed on the top face 21 of the heat sink 20. The power wiring part 40 has a power substrate 41. The power substrate 41 is electrically connected to the power module 30 through a conductive wire 31. Further, the power module 30 is electrically connected to the winding 13 through a motor wire 131. The drive electric current to be supplied to the winding 13 flows on the power substrate 41.

The control wiring part 50 is disposed on a bottom face 22 of the heat sink 20 (i.e., on a side opposite to the top face 21 of the heat sink 20). The control wiring part 50 has a control substrate 51. The control substrate 51 is electrically connected to the power module 30 through a conductive wire 32. The control electric current for controlling the power module 30 flows on the control substrate 51.

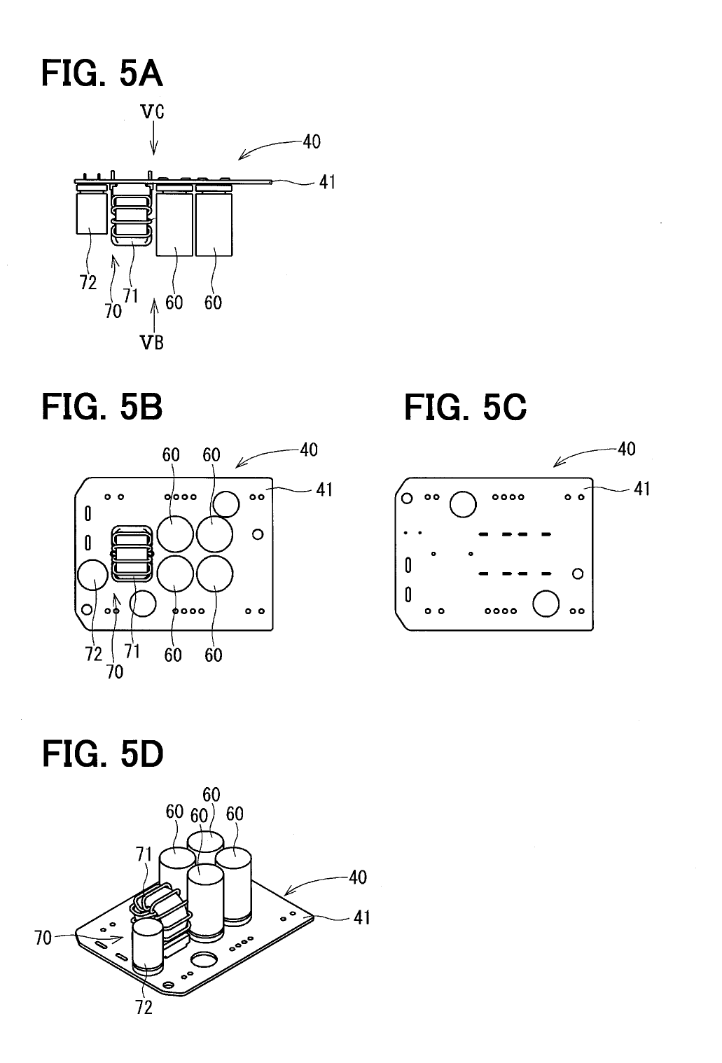

The electrolytic capacitor 60 is a component of the power wiring part 40 and is housed in the cavity 23 of the heat sink 20. The electrolytic capacitor 60 is, for example, a through-hole type electronic component, and is connected to the side of the power substrate 41 facing the heat sink 20. In the present embodiment, four electrolytic capacitors 60 are disposed (see FIG. 3 and FIG. 5). More practically, the electrolytic capacitor 60 is housed at a position corresponding to the first bottom face 24 of the cavity 23 (see FIG. 1). The electrolytic capacitor 60 is disposed, for example, for a purpose of reducing a ripple of the drive electric current. That is, the electrolytic capacitor 60 is used to provide a noise protection function.

In the present embodiment, a choke coil 71 and a capacitor 72 are used as the electronic components 70. The choke coil 71 and the capacitor 72 are disposed on a side of the heat sink 20 of the power wiring part 40 (see FIG. 1 and FIG. 3). More practically, the choke coil 71 is housed at a position corresponding to the second bottom face 25 of the cavity 23, to be implemented on the power substrate 41 (see FIG. 1). On the other hand, the capacitor 72 is not housed in the cavity 23, (i.e., is positioned at the cutout portion 27 outside of the cavity 23 to be implemented on the power substrate 41). The choke coil 71 and the capacitor 72 form a filter circuit, for removing noise from a power supply electric current.

The control part 80 includes a connector 81, a conductive wire 82, a cover 83 and the like. The connector 81 is connected to the control substrate 51 and is positioned to protrude from the motor case 11 in a radially-outward direction. The connector 81 is electrically connected to the power substrate 41 through the conductive wire 82. The cover 83 is formed in the shape of a cylinder having a bottom portion made from a material such as metal, for covering the heat sink 20, the power module 30, the power wiring part 40, the control wiring part 50, the electrolytic capacitor 60, and the electronic components 70.

A signal wire harness (not illustrated) for transmitting a signal is connected to the connector 81. A signal from the torque sensor 104, as well as a signal about an ignition voltage, a CAN signal, and the like are input to the connector 81 as a control signal to the control wiring part 50. Further, a power supply wire harness (not illustrated) for a power supply is connected to the connector 81 and an electric current for the winding 13, that is, the drive electric current is input to the connector 81. In this case, the drive electric current flows to the winding 13 through the connector 81, the conductive wire 82, the power substrate 41, the power module 30, and the motor wire 131.

A microcomputer 52 and a rotation angle sensor 53 are implemented on the control substrate 51 (i.e., on a side of the substrate 51 opposite to the heat sink 20 or on a side facing the rear end cap 18).

The microcomputer 52 has a CPU as an operation unit, a ROM and a RAM as a memory unit, together with an input and output unit and the like. The microcomputer 52 controls a power supply for the winding 13, by performing various arithmetic operations according to a program stored in the ROM based on a signal from the torque sensor 104, a signal about the ignition voltage, other CAN signal and the like, that are input through the connector 81 and by controlling the power module 30. When a power supply is provided for the winding 13, a rotating magnetic field is generated by the stator 12. In such manner, the rotor 14 rotates with the shaft 15, and the rotation of the rotor 14 is output from the output rod 16. Thus, the rotating electric machine 1 is a mechanism plus controller in a single body type rotating electric machine, in which the motor part 10 and the control part 80 for controlling the motor part 10 are combined in a single body.

Further, in the present embodiment, a permanent magnet 151 is disposed on the rear end of the shaft 15, on the opposite side of the shaft 15 relative to the output rod 16. The rotation angle sensor 53 detects a rotation angle of the shaft 15 and the rotor 14 by detecting a magnetic flux of the permanent magnet 151. The rotation angle sensor 53 outputs a signal regarding the rotation angle of the shaft 15 and the rotor 14 to the microcomputer 52. In such a manner, the microcomputer 52 may control the rotation of the rotor 14 without losing steps.

The arrangement of the heat sink 20 is described in more details in the following.

As shown in FIG. 1, the heat sink 20 is disposed so that the top face 21 is perpendicular to an axis Ax of the motor case 11. Further, the rotating electric machine 1 is installed on the housing 110 of the reduction gear 103 as shown in FIG. 2, so that the axis Ax of the motor case 11 is substantially aligned with the vertical direction and the output rod 16 points vertically downward with respect to gravity. Therefore, in the installed state, (i.e., when the rotating electric machine 1 is disposed on the reduction gear 103), the top face 21 of heat sink 20 is perpendicular to the vertical direction with respect to gravity. In other words, the heat sink 20 in the present embodiment is disposed so that the cavity 23 faces vertically upward with respect to gravity.

In this case, by designating an angle between a virtual straight line L1, where the virtual straight line L1 is perpendicular to the top face 21 of the heat sink 20, and a virtual plane P1, where virtual plane P1 is perpendicular to the vertical direction with respect to gravity as an angle α, the rotating electric machine 1 in the present embodiment is disposed on the reduction gear 103 such that the angle α is substantially equal to 90 degrees (see FIG. 1 and FIG. 2).

Further, in the present embodiment, the cavity 23 may have a space S1 which has a volume defined by (i) the virtual plane P1 including a lowest-most point of the open end of the heat sink 20 (i.e., the dashed line in FIG. 1, FIG. 4B, FIG. 4D) relative to the vertical downward direction with respect to gravity and (ii) the inner wall (i.e., the first bottom face 24, the second bottom face 25, and the side face 26). A volume difference of the cavity 23 (i.e., the volume of the hatched region in FIG. 1) may be calculated by subtracting the volume of the components within the space S1 from the volume of the space S1. That is, the volume difference of the cavity 23 is calculated by subtracting the volume of the electrolytic capacitor 60 and the electronic components 70 (i.e., the choke coil 71) from the volume of the space S1.

The volume difference of the cavity 23 is equal to or greater than the volume of electrolytic solution contained in at least one electrolytic capacitor 60. In such a manner, even if one of the electrolytic capacitors 60 leaks electrolytic solution, the electrolytic solution leaking from the electrolytic capacitor 60 may be contained in the cavity 23. Therefore, the electrolytic solution is prevented from dripping onto the control wiring part 50 positioned below the heat sink 20.

As described above, the electrolytic capacitor 60 is housed within the cavity 23 of the heat sink 20 in the present embodiment, by the arrangement of the capacitor 60 separated from and positioned on an opposite side of the control wiring part 50 relative to the heat sink 20. In other words, the side of the electrolytic capacitor 60 facing the control wiring part 50 is almost entirely covered by the heat sink 20. Therefore, even if the electrolytic capacitor 60 explodes due to an excessive and/or abnormal applied electric current, a broken piece of the exploded capacitor 60 is prevented from contacting the control wiring part 50 and causing damage to the control wiring part 50. Therefore, a situation causing an abnormality of the electrolytic capacitor 60 (i.e., an explosion) leading to an abnormality of the control wiring part 50 is avoided.

Further, in the present embodiment, when the rotating electric machine 1 is disposed on the reduction gear 103, the top face 21 of the heat sink 20 is arranged perpendicular to the vertical direction with respect to gravity. That is, the heat sink 20 in the present embodiment is disposed so that the cavity 23 faces vertically upward with respect to gravity. Therefore, even if the electrolytic capacitor 60 explodes due to an excessive and/or abnormal applied electric current such that electrolytic solution leaks from the electrolytic capacitor 60, the cavity 23 catches the electrolytic solution. Therefore, the leaking electrolytic solution from the electrolytic capacitor 60 is prevented from dripping on the control wiring part 50. Therefore, a situation causing an abnormality of the electrolytic capacitor 60 (i.e., solution leakage) resulting in an abnormality of the control wiring part 50 may be avoided.

In the present embodiment, an abnormality in the electrolytic capacitor 60 is prevented from causing an abnormality in the control wiring part 50 as described above.

Further, in the present embodiment, when designating an angle between a virtual straight line L1, where the virtual straight line L1 is perpendicular to the top face 21 of the heat sink 20, and a virtual plane P1, where the virtual plane P1 is perpendicular to the vertical direction at an angle α, the rotating electric machine 1 is disposed on the reduction gear 103 such that the angle α is substantially equal to 90 degrees (see FIG. 1 and FIG. 2).

Further, in the present embodiment, the cavity 23 may have a space S1 with a volume defined by (i) the virtual plane P1 that includes a lowest-most point of the open end of the heat sink 20 (i.e., the dashed line in FIG. 1, FIG. 4B, FIG. 4D) relative to the vertical downward direction with respect to gravity and (ii) the inner wall (i.e., the first bottom face 24, the second bottom face 25, and the side face 26). A volume difference of the cavity 23 (i.e., the volume of the hatched region in FIG. 1) may be calculated by subtracting the volume of the components within the space S1 from the volume of the space S1. That is, the volume difference of the cavity 23 is calculated by subtracting the volume of the electrolytic capacitor 60 and the electronic components 70 (i.e., the choke coil 71) from the volume of the space S1.

The volume difference of the cavity 23 is equal to greater than the volume of electrolytic solution contained in at least one electrolytic capacitor 60. In such a manner, even if one of the electrolytic capacitors 60 leaks electrolytic solution, the electrolytic solution leaking from the electrolytic capacitor 60 may be contained in the cavity 23. Therefore, the electrolytic solution is prevented from dripping onto the control wiring part 50 positioned below the heat sink 20. Furthermore, a situation causing an abnormality of the electrolytic capacitor 60 (i.e., solution leakage) resulting in an abnormality of the control wiring part 50 may be prevented.

### Second Embodiment

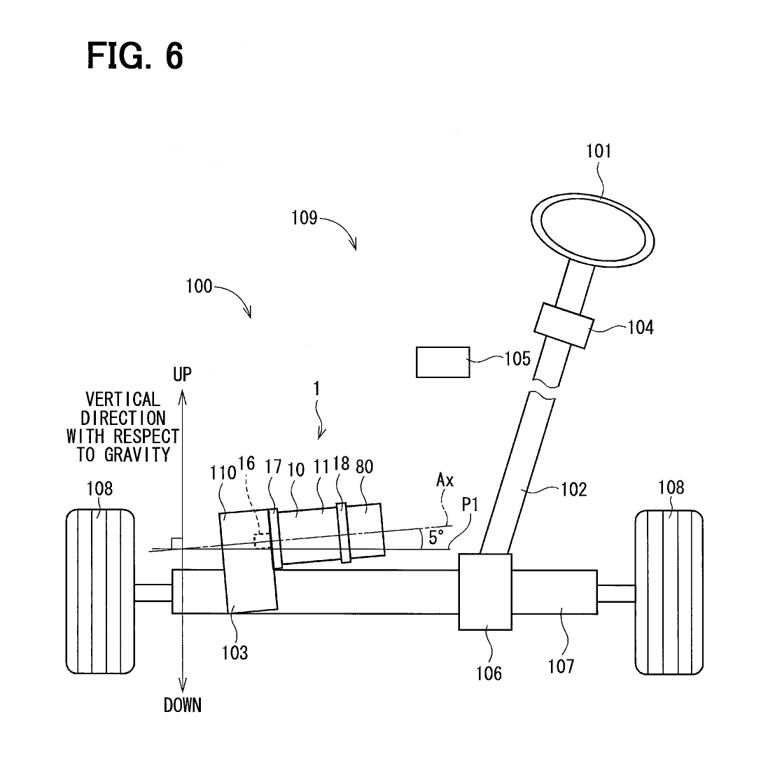

FIG. 6 shows an electric power steering apparatus in the second embodiment of the present disclosure.

The second embodiment is different from the first embodiment in that the reduction gear 103 is disposed on the steering rack 107. The rotating electric machine 1 is installed on the housing 110 of the reduction gear 103. The reduction gear 103 reduces a rotation speed of the rotating electric machine 1 and transmits the rotation to the steering rack 107. In other words, the electric power steering apparatus 109 in the second embodiment is an electric power steering apparatus of the rack-assist type.

As shown in FIG. 6, the rotating electric machine 1 is installed on the housing 110 of the reduction gear 103 in the present embodiment, so that the axis Ax of the motor case 11 is angled about 5 degrees relative to the virtual plane P1, where the virtual plane P1 is perpendicular to the vertical direction with respect to gravity. Therefore, the top face 21 of the heat sink 20 is angled about 5 degrees relative to the vertical direction with respect to gravity when the rotating electric machine 1 is installed on the reduction gear 103.

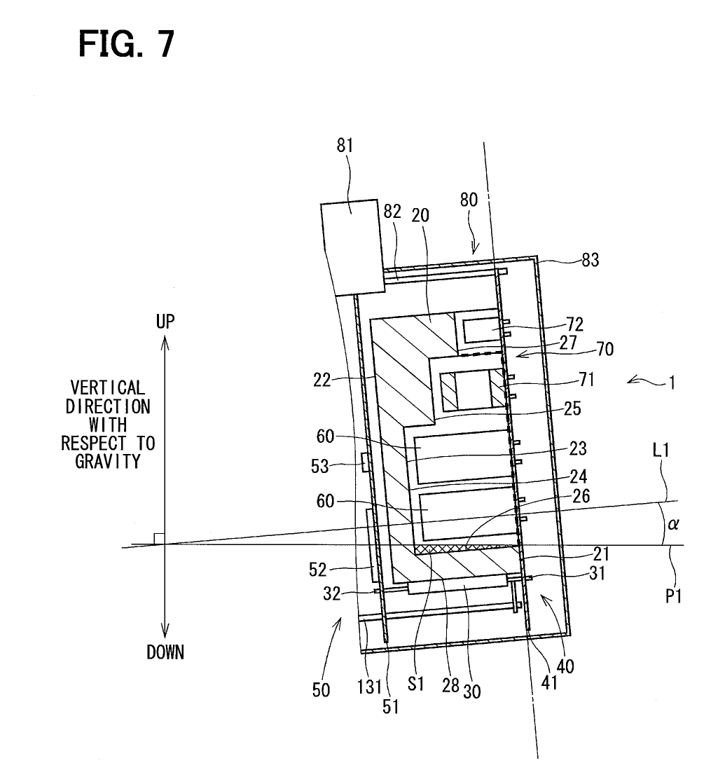

In this case, by designating an angle between the virtual straight line L1, where the virtual straight line L1 is perpendicular to the top face 21 of the heat sink 20 and the virtual plane P1, where the virtual plane P1 is perpendicular to the vertical direction with respect to gravity as an angle α, the rotating electric machine 1 in the present embodiment is disposed on the reduction gear 103 such that the angle α is substantially equal to 5 degrees (see FIG. 6 and FIG. 7).

Further, in the present embodiment, the cavity 23 may have a space S1 with a volume defined by (i) the virtual plane P1 that includes a lowest-most point of the open end of the heat sink 20 (i.e., the dashed line in FIG. 7) in the vertical downward direction with respect to gravity and (ii) the inner wall (i.e., the first bottom face 24, the second bottom face 25, and the side face 26). A volume difference of the cavity 23 (i.e., the volume of the hatching region in FIG. 7) may be calculated by subtracting the volume of the components within the space S1 from the volume of the space S1. That is, the volume difference of the cavity 23 is calculated by subtracting the volume of the electrolytic capacitor 60 and the electronic components 70 (i.e., the choke coil 71) from the volume of the space S1.

The volume difference of the cavity 23 is greater than the volume of electrolytic solution contained in at least one electrolytic capacitor 60. In such a manner, even if one of the electrolytic capacitors 60 leaks electrolytic solution, the electrolytic solution leaking from the electrolytic capacitor 60 may be contained in the cavity 23. Therefore, the electrolytic solution is prevented from dripping onto the control wiring part 50 positioned below the heat sink 20. Furthermore, a situation causing an abnormality of the electrolytic capacitor 60 (i.e., solution leakage) resulting in an abnormality of the control wiring part 50 may be avoided.

### Other Embodiments

In the above-described first embodiment, the rotating electric machine is disposed at a position close to a drive object so that the virtual straight line that is perpendicular to the top face of the heat sink and the virtual plane that is perpendicular to the vertical direction form an angle of 90 degrees. Further, in the second embodiment, the rotating electric machine is disposed at a position close to a drive object so that the virtual straight line that is perpendicular to the top face of the heat sink and the virtual plane that is perpendicular to the vertical direction form an angle of 5 degrees. Different from such configurations in the other embodiments of the present disclosure, the rotating electric machine may be disposed at a position close to a drive object so that the virtual straight line that is perpendicular to the top face of the heat sink and the virtual plane that is perpendicular to the vertical direction form an angle that is greater than 5 degrees but less than 90 degrees. In such a manner, even if one of the electrolytic capacitors 60 leaks electrolytic solution, the electrolytic solution leaking from the electrolytic capacitor 60 is contained in the cavity 23.

Further, in other embodiments of the present disclosure, the rotating electric machine may be disposed at a position close to a drive object such that the cavity of the heat sink faces any direction. In the present disclosure, a side of the control wiring part of the electrolytic capacitor is almost entirely covered by the heat sink. As a result, the cavity may have an open end and a volume of space inside of the cavity such that the volume difference of the cavity may be calculated by subtracting volumes of the electrolytic capacitor and the electronic components from the volume of space inside of the cavity. Therefore, even if the electrolytic capacitor explodes, the piece of the exploded electrolytic capacitor is prevented from contacting the control wiring part, thus preventing damage of the control wiring part.

Additionally, in the other embodiments of the present disclosure, as long as (i) the power wiring part is disposed on one side of the heat sink, (ii) the control wiring part is disposed on the opposite side of the heat sink relative to the power wiring part, and (iii) the electrolytic capacitor is disposed in the power wiring part to be housed in the cavity of the heat sink, the control part including the heat sink may be disposed on either side of the axial direction of the motor case, taking any installation position.

Moreover, in the other embodiments of the present disclosure, the heat sink is not required to have a cutout portion.

Even further, in the other embodiments of the present disclosure, the cavity of the heat sink may house any number of electrolytic capacitors.

Furthermore, in the other embodiments of the present disclosure, the choke coil may be positioned outside of the cavity of the heat sink, with other electronic components.

The present disclosure may be used as a drive source for a device other than an electric power steering apparatus.

Although the present disclosure has been fully described in connection with the above embodiments with reference to the accompanying drawings, it is to be noted that various changes and modifications will become apparent to those skilled in the art, and such changes and modifications are to be understood as being within the scope of the present disclosure as defined by the appended claims.

What is claimed is:

1. A rotating electric machine for driving a drive object, comprising:
a motor case having a cylinder shape;
a stator housed in the motor case;
a winding wound on the stator;
a rotor rotatably disposed inside of the stator;
a shaft coupled to and disposed at a center of the rotor;
an output rod disposed on the shaft and outputting the rotation of the rotor to a drive object through a connection with the drive object;
a heat sink disposed on the motor case in an axial direction, having a cavity on a first face of the heat sink;
a power module disposed on the heat sink and switching a power supply for the winding;
a power wiring part disposed on the first face of the heat sink to be electrically connected to the power module and flowing a drive electric current to the winding;
a control wiring part disposed on a second face of the heat sink to be electrically connected to the power module and flowing a control electric current for controlling the power module;
at least one electrolytic capacitor disposed in the power wiring part and housed in the cavity; and
electronic components disposed on a side of the power wiring part facing the first face of the heat sink.

2. The rotating electric machine of claim 1, wherein
a virtual straight line is perpendicular to the first face of the heat sink, a virtual plane is perpendicular to a vertical direction with respect to gravity, and the rotating electric machine is positioned such that an angle between the virtual straight line and the virtual plane is equal to or greater than 5 degrees.

3. The rotating electric machine of claim 1, wherein
a virtual straight line is perpendicular to the first face of the heat sink, a virtual plane is perpendicular to a vertical direction with respect to gravity, and the rotating electric machine is positioned such that an angle between the virtual straight line and the virtual plane is equal to 90 degrees.

4. The rotating electric machine of claim 2, wherein
the cavity is defined by cavity walls and an open end such that a volume of space inside of the cavity is defined by (i) the virtual plane that includes a lowest-most point of the open end of the cavity relative to the vertical downward direction with respect to gravity and (ii) the cavity walls, and a volume difference of the cavity is calculated by subtracting volumes of the electrolytic capacitor and the electronic components from the volume of space inside of the cavity.

5. The rotating electric machine of claim 4, wherein
the volume difference of the cavity is greater than a volume of electrolytic solution contained in at least one electrolytic capacitor.

6. The rotating electric machine of claim 1, wherein
the cavity has an open end, a volume of space inside of the cavity, and a volume difference of the cavity calculated by subtracting volumes of the electrolytic capacitor and the electronic components from the volume of space inside of the cavity.

7. The rotating electric machine of claim 6, wherein
the volume difference of the cavity is greater than a volume of electrolytic solution contained in at least one electrolytic capacitor.

8. An electric power steering apparatus comprising:
a motor case having a cylinder shape;
a stator housed in the motor case;
a winding wound on the stator;
a rotor rotatably disposed inside of the stator;
a shaft coupled to and disposed at a center of the rotor;
an output rod disposed on the shaft and outputting the rotation of the rotor to a drive object through a connection with the drive object, wherein the drive object is driven to output an assist torque for steering;
a heat sink disposed on the motor case in an axial direction, having a cavity on a first face of the heat sink;
a power module disposed on the heat sink and switching a power supply for the winding;
a power wiring part disposed on the first face of the heat sink to be electrically connected to the power module and flowing a drive electric current to the winding;
a control wiring part disposed on a second face of the heat sink to be electrically connected to the power module and flowing a control electric current for controlling the power module;
at least one electrolytic capacitor disposed in the power wiring part and housed in the cavity; and
electronic components disposed on a side of the power wiring part facing the first face of the heat sink.
